(19) United States
(12) Patent Application Publication
(10) Pub. No.: US 2018/0169598 A1
(43) Pub. Date: Jun. 21, 2018

(54) Systems and Methods For Gas Evolution and Dissolution

(71) Applicants: Chevron U.S.A. Inc., San Ramon, CA (US); The Board of Regents for Oklahoma State University, Stillwater, OK (US)

(72) Inventors: David Michael Lavenson, Houston, TX (US); Aniruddha V. Kelkar, Houston, TX (US); Gene E. Kouba, Houston, TX (US); Clint P. Aichele, Stillwater, OK (US); Alden Brack Daniel, Stillwater, OK (US); Sayeed Mohammad, Stillwater, OK (US)

(21) Appl. No.: 15/385,059

(22) Filed: Dec. 20, 2016

(51) Int. Cl. B01F 15/00; B01F 3/04; B01F 7/20

(52) U.S. Cl. CPC B01F 15/00253; B01F 3/04531; B01F 7/20; B01F 3/04602; B01F 15/00285; B01F 15/00915; B01F 15/00129

(57) ABSTRACT

A system for evolving and dissolving a gas with a liquid can include a pressure vessel in which a liquid mixed with a gas is disposed, and a gas source coupled to the pressure vessel. The system can also include at least one regulating device that regulates a parameter within the pressure vessel. The system can further include at least one sensor that measures at least one parameter as a function of time, where the at least one parameter is associated with the gas within the pressure vessel. The system can also include a controller that controls the regulating device based on measurements of the at least one parameter taken by the at least one sensor, to evolve and dissolve the gas within the pressure vessel.

### TECHNICAL FIELD

The present disclosure relates generally to the manipulation of gas, and more specifically to measuring the rates of the evolution from and dissolution of gas in liquid over time.

### BACKGROUND

Gas evolution is a physical or chemical process where gas is produced as free gas or bubbles or foam from a supersaturated solution (storing more gas than the “saturation level” governed by thermodynamics (e.g., system pressure, temperature, and composition)). Gas dissolution is a different physical or chemical process by which a gas (in the form of free gas, bubbles or foam) is transferred to an undersaturated solution (storing less gas than the thermodynamic “saturation level”). Factors such as system temperature and pressure, level of agitation, and fluid properties affect gas evolution and gas dissolution. Gas evolution and dissolution is encountered in and can be used in a number of applications. For example, gas evolution occurs in carbonated beverages, where carbon dioxide is evolved at the time the beverage is served.

### SUMMARY

In general, in one aspect, the disclosure relates to a system for evolving and dissolving a gas with a liquid. The system can include a pressure vessel in which the liquid mixed with the gas is disposed. The system can also include at least one regulating device that regulates a parameter within the pressure vessel. The system can further include at least one sensor that measures the at least one parameter as a function of time, where the at least one parameter is associated with the gas within the pressure vessel. The system can also include a controller coupled to the at least one sensor and the at least one regulating device, where the controller controls the at least one regulating device, based on measurements of the at least one parameter taken by the at least one sensor, to evolve and dissolve the gas within the pressure vessel.

In another aspect, the disclosure can generally relate to a method for studying characteristics of a gas in the presence of a liquid. The method can include filling a pressure vessel with the liquid, where the liquid comprises the gas therein. The method can also include pressurizing, using a controller that controls a pressure regulating device based on a first plurality of measurements at a first time made by at least one sensor, the pressure vessel to a first pressure. The method can further include allowing the liquid and gas inside the pressure vessel to equilibrate. The method can also include measuring, using the at least one sensor, a second plurality of measurements at a second time. The method can further include evaluating, using the controller, the first plurality of measurements, and the second plurality of measurements, the characteristics of the gas during dissolution.

In yet another aspect, the disclosure can generally relate to a method for studying characteristics of a gas in the presence of a liquid. The method can include saturating a combination of the liquid and the gas within the pressure vessel. The method can also include agitating, using a mixing device controlled by a controller, the gas and the liquid within the pressure vessel. The method can further include measuring, using at least one sensor, a plurality of measurements at a first time. The method can also include evaluating, using the controller and the plurality of measurements, the characteristics of the gas during evolution.

These and other aspects, objects, features, and embodiments will be apparent from the following description and the appended claims.

### BRIEF DESCRIPTION OF THE DRAWINGS

The drawings illustrate only example embodiments of methods, systems, and devices for causing, enhancing, detecting, and/or measuring rates of gas evolution and dissolution. Example embodiments can be applied to any of a number of applications. For instance, example embodiments can be used during a production field operation of a subterranean formation. Therefore, example embodiments described herein are not to be considered limiting of its scope, as gas evolution and dissolution may admit to other equally effective embodiments and/or applications. This is similarly applied to drawings illustrating any systems described herein. The elements and features shown in the drawings are not necessarily to scale, emphasis instead being placed upon clearly illustrating the principles of the example embodiments. Additionally, certain dimensions or positionings may be exaggerated to help visually convey such principles. In the drawings, reference numerals designate like or corresponding, but not necessarily identical, elements.

FIG. 1 shows a schematic diagram of a field system in which example embodiments can be applied.

FIGS. 2A and 2B show a system diagram for evolving and dissolving gas in accordance with certain example embodiments.

FIG. 3 shows a diagram of a controller in accordance with certain example embodiments.

FIG. 4 shows a graph depicting the effect of shear on gas evolution in accordance with certain example embodiments.

FIGS. 5A and 5B show graphs related to gas evolution in accordance with one or more example embodiments.

FIG. 6 is a flowchart of a method for evolving and dissolving gas in accordance with one or more example embodiments.

FIG. 7 shows a computing device in accordance with certain example embodiments.

### DETAILED DESCRIPTION OF EXAMPLE EMBODIMENTS

The example embodiments discussed herein are directed to systems, apparatuses, and methods of evolving and dissolving gases. While the example systems for evolving and dissolving gases described herein are directed toward production field operations, example systems for evolving and dissolving gases are not limited to production field operations. Examples of other applications that can be used with example systems for evolving and dissolving gases can include, but are not limited to, industrial operations, chemical plants, biomedical practice, separators, pumps, tanks, and production facilities.

A liquid as used herein can be any one or more substances that are free flowing and having constant volume. Examples of a liquid can include, but are not limited to, water, drilling mud, blood, liquid sulfur, polymers, and oil. A gas as used herein can be one or more of any air-like fluid substances that expand freely to fill any space available (e.g., head space). A gas as used herein can be a free gas, bubbles, gas that is in solution, and/or foam. Examples of a gas can include, but are not limited to, natural gas, nitrogen, methane, air, hydrogen sulfide, carbon monoxide, and carbon dioxide.

Example embodiments can be used in a laboratory setting. Alternatively, example embodiments can be used in a production or other real-time application (e.g., in an operating room, at a drilling site, at a production facility, at an accident site). In any case, because of the high pressures involved, as well as the extended periods of time that the high pressures can be maintained, adequate safety precautions can be taken to ensure that any accidents are contained and do not adversely affect people or other equipment.

A user as described herein may be any person that is involved with evolving and/or dissolving gases. Examples of a user may include, but are not limited to, a company representative, a drilling engineer, a field engineer, a chemist, a lab technician, an operator, a consultant, a contractor, and a manufacturer's representative. The systems for evolving and dissolving gases (including any components thereof) described herein can be made of one or more of a number of suitable materials to allow the systems for evolving and dissolving gases to maintain reliable and effective operations, meet certain standards and/or regulations, and also maintain durability in light of the one or more conditions (e.g., marine, high pressure, high temperature, subterranean) under which the systems for evolving and dissolving gases can be exposed and/or operate under. Examples of such materials can include, but are not limited to, aluminum, stainless steel, fiberglass, glass, plastic, ceramic, and rubber.

If a component of a figure is described but not expressly shown or labeled in that figure, the label used for a corresponding component in another figure can be inferred to that component. Conversely, if a component in a figure is labeled but not described, the description for such component can be substantially the same as the description for the corresponding component in another figure. The numbering scheme for the various components in the figures herein is such that each component is a three digit number and corresponding components in other figures have the identical last two digits.

In addition, a statement that a particular embodiment (e.g., as shown in a figure herein) does not have a particular feature or component does not mean, unless expressly stated, that such embodiment is not capable of having such feature or component. For example, for purposes of present or future claims herein, a feature or component that is described as not being included in an example embodiment shown in one or more particular drawings is capable of being included in one or more claims that correspond to such one or more particular drawings herein.

In the foregoing figures showing example embodiments of systems for gas evolution and dissolution, one or more of the components shown may be omitted, repeated, and/or substituted. Accordingly, example embodiments of systems for gas evolution and dissolution should not be considered limited to the specific arrangements of components shown in any of the figures. For example, features shown in one or more figures or described with respect to one embodiment can be applied to another embodiment associated with a different figure or description.

Example embodiments of systems for gas evolution and dissolution are described more fully hereinafter with reference to the accompanying drawings, in which example embodiments of systems for gas evolution and dissolution are shown. Systems for gas evolution and dissolution may, however, be embodied in many different forms and should not be construed as limited to the example embodiments set forth herein. Rather, these example embodiments are provided so that this disclosure will be thorough and complete, and will fully convey the scope of systems for gas evolution and dissolution to those of ordinary skill in the art. Like, but not necessarily the same, elements (also sometimes called components) in the various figures are denoted by like reference numerals for consistency.

Terms such as “first,” “second,” “top,” “bottom,” “proximal”, “distal”, “inner,” “outer,” “within”, “front”, “rear”, and “side” are used merely to distinguish one component (or part of a component or state of a component) from another. Such terms are not meant to denote a preference or a particular orientation, and are not meant to limit embodiments of systems for gas evolution and dissolution. In the following detailed description of the example embodiments, numerous specific details are set forth in order to provide a more thorough understanding of the invention. However, it will be apparent to one of ordinary skill in the art that the invention may be practiced without these specific details. In other instances, well-known features have not been described in detail to avoid unnecessarily complicating the description.

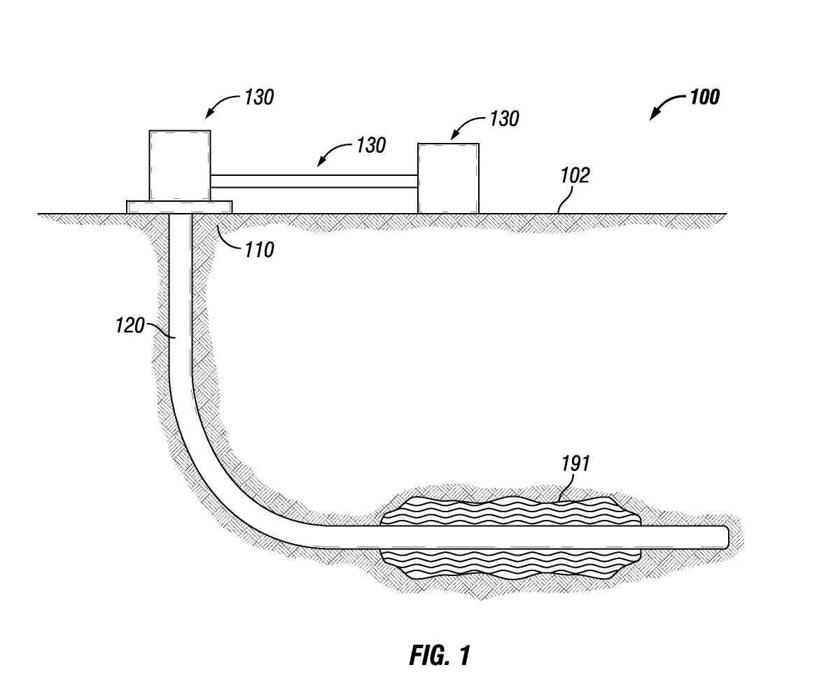

FIG. 1 shows a schematic diagram of a production field system 100 from a subterranean formation in accordance with one or more example embodiments. Referring now to FIG. 1, the production field system 100 in this example includes a wellbore 120 that is formed in a subterranean formation 110 using production equipment 130 above a surface 102, such as ground level for an on-shore application and the sea floor for an off-shore application. The point where the wellbore 120 begins at the surface 102 can be called the entry point. The subterranean formation 110 can include one or more of a number of formation types, including but not limited to shale, limestone, sandstone, clay, sand, and salt. In certain embodiments, a subterranean formation 110 can also include one or more reservoirs in which one or more subterranean resources 191 (e.g., oil, gas, water, steam) can be located. One or more of a number of field operations (e.g., drilling, setting casing, extracting downhole resources, production) can be performed to reach an objective of a user with respect to the subterranean formation 110.

The wellbore 120 can have one or more of a number of segments, where each segment can have one or more of a number of dimensions. Examples of such dimensions can include, but are not limited to, size (e.g., diameter) of the wellbore 120, a curvature of the wellbore 120, a total vertical depth of the wellbore 120, a measured depth of the wellbore 120, and a horizontal displacement of the wellbore 120. During a production operation, casing can line most, if not all, of the wellbore 120.

The production equipment 130 can be used to extract the subterranean resources 191 through the wellbore 120 and process/transport the subterranean resources 191. The production equipment 130 can be positioned and/or assembled at the surface 102. The production equipment 130 can include, but is not limited to, a derrick, pumps, motors, drill pipe, tubing pipe, a power source, a pipeline, a remote process facility, and casing pipe. The production equipment 130 can also include one or more devices that measure and/or control various aspects of a production field operation associated with the wellbore 120. For example, the production equipment 130 can include a wireline tool that is run through the wellbore 120 to provide detailed information (e.g., curvature, azimuth, inclination) throughout the wellbore 120. Such information can be used for one or more of a number of purposes. For example, such information can dictate the size (e.g., outer diameter) of a casing pipe to be inserted at a certain depth in the wellbore 120.

When a subterranean resource 191 (e.g., natural gas) is extracted from the subterranean formation 110 into the wellbore 120, it can be suspended in a liquid (e.g., drilling mud) and cannot easily be separated. This can occur for any of a number of reasons, such as the high pressure and/or temperature that exists within the wellbore 120, particularly at great depths (e.g., thousands of feet below the surface 102). In typical gas evolution in such a case, the liquid in which the subterranean resource 191 is suspended is disturbed (e.g., change the pressure, change the temperature) to super-saturate the liquid, which evolves the subterranean resource 191 into a gas state, separating the subterranean resource 191 out of the liquid.

In the current art, this process of evolving gas from the super-saturated liquid is assumed to be a substantially instantaneous process that is performed rapidly and without any type of control. However, experience shows that this assumption is often incorrect. In part, example embodiments described herein are designed to help predict the amount of time that evolution of a gas occurs for a liquid under a given set of conditions (e.g., pressure, temperature, liquid properties, flow parameters). Similarly, example embodiments described herein are designed to help predict the amount of time that dissolution of a gas can occur under a given set of conditions (e.g., pressure, temperature, gas parameters).

The ability to predict and control the rate at which a gas evolves or dissolves can result in a number of benefits. For example, example embodiments lead to understanding the parameters (e.g., pressure, temperature, turbulance) that most efficiently evolve a gas from a liquid based on certain elements (e.g., emulsions, hydrates, waxes, asphaltenes, sand) found in the liquid. In this way, the extraction of a subterranean resource 191 during a field operation can be maximized more efficiently.

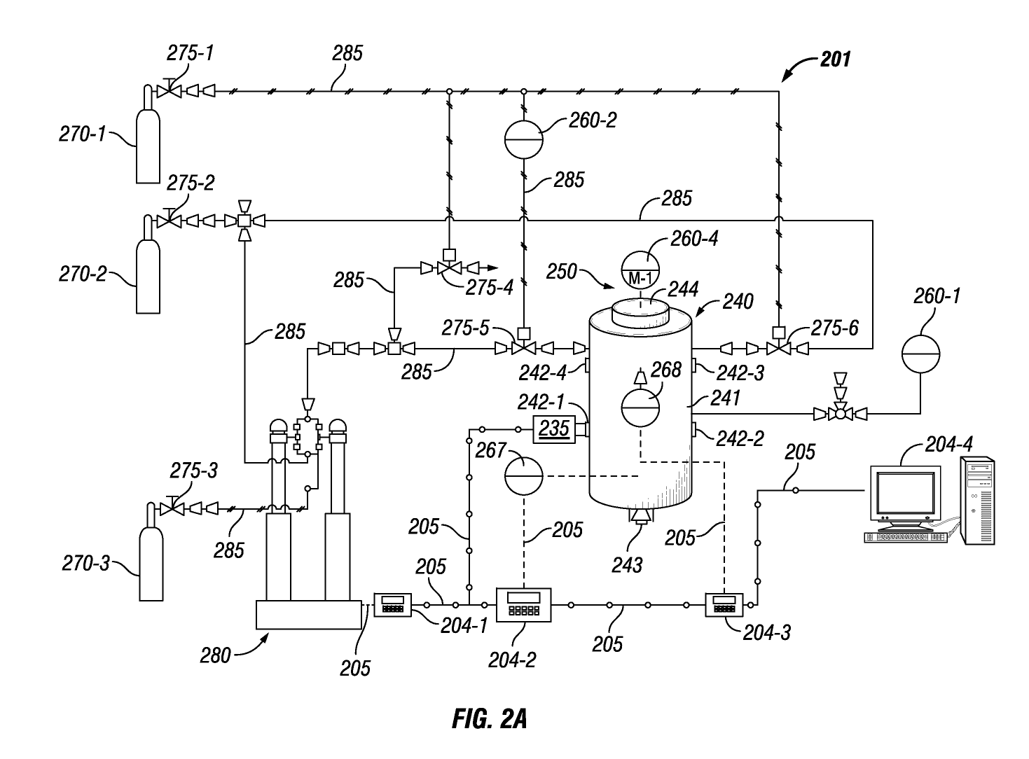

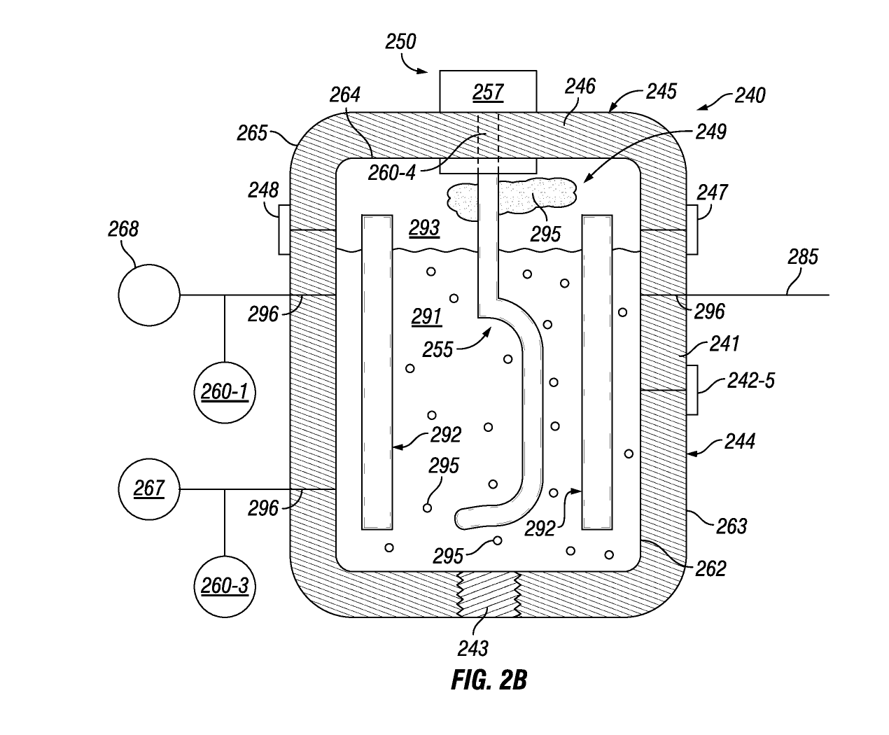

FIGS. 2A and 2B show a system 201 for evolving and dissolving gas in accordance with certain example embodiments. Referring to FIGS. 1-2B, the system 201 can include any of a number of components. In this case, as shown in FIG. 2A, the system 201 includes a pressure vessel 240, at least one sensor 260 (also called a sensor device 260 herein), one or more controllers 204, one or more pressure vessel (PV) content sources 270, at least one pump 280, a mixing device 250, and an optional image capture device 235. These various components of the system 201 can be connected to at least one other component of the system 201 using piping 285 and/or signal transfer links 205. If piping 285 is used, one or more control devices 275 (e.g., valves, regulators) can be used to regulate the medium (e.g., liquid, gas) that flows therethrough. FIG. 2B shows a cross-sectional side view of the pressure vessel 240 and some associated components.

The pressure vessel 240 can be a container of any shape and/or size. The pressure vessel 240 can be designed to withstand a wide range of pressures (e.g., 1 atmosphere, 10,000 psia) and/or temperatures (e.g., 150° C., −100° C.). The pressure vessel 240 can have a cavity that is designed to hold gases, liquids, and/or solids. The pressure vessel 240 can be designed to hold any type of compound and/or material, including but not limited to acids, volatile compounds, corrosive material, bases, and water.

The pressure vessel 240 can also have any of a number of configurations. For example, as shown in FIG. 2B, the pressure vessel 240 can have a body 244 and a cover 245 that couples to the body 244. In this case, the cover 245 is hingedly coupled to the body 244 by a hinge 247. Further, the cover 245 is secured to the body 244 by a latch mechanism 248. When viewed from above, the cover 245 and/or the body 244 can have any of a number of cross-sectional shapes. Such shapes can include, but are not limited to, a circle, an oval, a square, and an octagon.

The body 244 can have at least one wall 241 that forms a cavity 249. The wall 241 of the body 244 has an inner surface 262 and an outer surface 263. The inner surface 262 of the body 244 can have any of a number of textures and/or features. Examples of such textures and/or features can include, but are not limited to, smooth, dimpled, rough, sharp-angled corners, rounded corners, and no corners. The textures and/or features of the inner surface 262 of the body 244 can be substantially uniform or variable throughout.

Similarly, the cover 245 has at least one wall 246. When the cover 245 is coupled to the body 244, the cavity 249 becomes enclosed. The wall 246 of the cover 245 has an inner surface 264 and an outer surface 265. When the cover 245 is coupled to the body 244, the inner surface 264 at the distal end of the cover 245 can form a seamless transition with the inner surface 262 at the distal end of the body 244. The textures and/or features of the inner surface 264 of the cover 245 can be substantially the same as, or different than, the textures and/or features of the inner surface 262 of the body 244.

Within the cavity 249 can be disposed a liquid 291. When the liquid 291 is in an elevated pressure and/or temperature system, the liquid 291 has a gas 295 suspended therein. While FIG. 2B shows that there are bubbles of gas 295 in the liquid 291, this is not always the case. For example, the gas 295 can be “invisible” within the liquid 291. As another example, the gas 295 can be a foam within or on top of the liquid 291. In other words, the gas 295 mixed in the liquid 291 can have any one or more of a number of forms.

Through the evolution process within the cavity 249, the gas 295 evolves and accumulates in the headspace 293, which is the volume of space between the top of the liquid 291 and the inner surface 264 of the cover 245. When the gas 295 dissolves, at least most of the gas 295 (to the extent that the liquid 291 becomes saturated and can no longer absorb additional quantities of the gas 295) leaves the headspace 293 and becomes suspended in the liquid 291.

The cavity 249 of the pressure vessel 240 can be pressurized or depressurized by a pressure regulating device 268. The pressure regulating device 268 can increase, decrease, and/or maintain the pressure of the cavity 249. When the pressure regulating device 268 adjusts the pressure of the cavity 249, the adjustments can be made at any rate of change. Further, the range of pressures that can be generated by the pressure regulating device 268 can be at least as great as the range of pressures required to evolve and dissolve the gas 295 within the cavity 249.

The pressure regulating device 268 can include one or more of a number of components. Such components can include, but are not limited to, a pressure relief valve, a pressure regulating valve, fan, a pump, and a motor. The pressure regulating device 268 can be coupled to a controller 204 (in this case, controller 204-3), using signal transfer links 205, to receive power, control, and instructions from the controller 204, as well as to provide data and feedback to the controller 204.

In addition, or in the alternative, the temperature within the cavity 249 can be increased, decreased, and/or maintained using a temperature regulating device 267. When the temperature regulating device 267 adjusts the temperature of the cavity 249, the adjustments can be made at any rate of change. Further, the range of temperatures that can be generated by the temperature regulating device 267 can be at least as great as the range of temperatures required to evolve and dissolve the gas 295 within the cavity 249.

A temperature regulating device 267 can take on one or more of a number of forms, including but not limited to a resistive heating circuit and a cooling loop. A temperature regulating device 267 can include one or more of a number of components. Such components can include, but are not limited to, a fan, a pump, a motor, a heat exchanger, and a heating element. The temperature regulating device 267 can have any of a number of configurations. For example, the temperature regulating device 267 can indirectly control the temperature of the wall 241 of the body 244 of the pressure vessel 240, and the temperature of the wall 241 conducts to the contents within the cavity 249. As another example, thermal rods can be disposed within the cavity, and the temperature of the thermal rods transfers to the liquid 291 within the cavity 249. The temperature regulating device 267 can be coupled to a controller 204 (in this case, controller 204-2), using signal transfer links 205, to receive power, control, and instructions from the controller 204, as well as to provide data and feedback to the controller 204. The pressure regulating device 268 and the temperature regulating devices 267 can more generally be referred to herein as regulating devices.

In certain example embodiments, the contents (e.g., liquid 291, gas 295) within the cavity 249 of the pressure vessel 240 can be agitated. As discussed below, parameters (e.g., voltage, current) associated with the power used to move the agitator can be measured by one or more sensor devices 260. The agitation of the contents within the cavity 249 can occur in one or more of a number of ways. Examples of how the contents within the cavity 249 can be agitated can include, but are not limited to, stirring, shaking, inversion, and centrifugal rotation.

In this case, a mixing device 250 is used to agitate (e.g., stir) the contents within the cavity 249. The mixing device 250 can include one or more of a number of components. Examples of such components can include, but are not limited to, a motor, a paddle, an impeller, a stir bar, compressed air, a vibrating frame (e.g., for a shaker table), a gear box, a recirculation pump, one or more baffles, magnets (for magnetically coupling the motor 257 to the paddle 255), and a shaft. If there are multiple components used for mixing, agitating, and/or otherwise disturbing the contents within the cavity 249 of the pressure vessel 240, such components can be used individually (at different times) from each other and/or in conjunction with (at the same time as) each other. In this case, the mixing device 250 can include a paddle 255 that is disposed in the cavity 249 and rotated within the cavity 249 by a motor 257 (e.g., a variable frequency drive), which is disposed on the outer surface 265 of the cover 245.

There can also be one or more optional components or devices within the cavity 249 to aid in agitating the contents within the cavity 249 of the pressure vessel 240. For example, as shown in FIG. 2B, one or more baffles 292 can be disposed within the cavity 249 to control how the liquid 291 flows as the liquid 291 is stirred by the paddle 255. Similarly, features and/or textures on the inner surface 262 of the wall 241 of the body 244 can achieve similar results.

In certain example embodiments, there can be one or more view ports 242 disposed in the wall 241 of the body 244 and/or the wall 246 of the cover 245. In this case, there are five view ports 242 (view port 242-1, view port 242-2, view port 242-3, view port 242-4, and view port 242-5) disposed in the wall 241 of the body 244. In such a case, one or more image capture devices 235 (e.g., still camera, video camera) can be used to capture images of the contents within the cavity 249 through a viewport 242. An image capture device 235 can use one or more of any number of image capturing technologies, including but not limited to thermal, infrared, and digital. The image capture device 235 can be coupled to a controller 204 (in this case, controller 204-1), using signal transfer links 205, to receive power, control, and instructions from the controller 204, as well as to provide data and feedback to the controller 204.

The body 244 of the pressure vessel 240 can include one or more drain plug 243 disposed in the wall 241 of the body 244. The drain plug 243 can be used for pressure relief and/or to drain the liquid 291 within the cavity 249. A drain plug 243 can be disposed at any location in the wall 241 of the body 244. For example, in this case, the drain plug 243 is located in the wall 241 that defines the bottom of the body 244. In certain example embodiments, there can be one or more ports 296 through which one or more sensor devices 260 (or portions thereof) can be disposed. These ports 296 can penetrate some or all of the wall 241 of the body 244 and/or some or all of the wall 246 of the cover 245 of the pressure vessel 240. One or more ports 296 can also traverse a wall (e.g., wall 241) of the pressure vessel to allow for the injection and/or removal of a liquid (e.g., liquid 291) and/or a gas (e.g., gas 295) relative to the cavity 249 of the pressure vessel 240.

In certain example embodiments, the system 201 can include one or more sensor devices 260. The one or more sensor devices 260 can be any type of sensing device that measure one or more parameters. Examples of types of sensor devices 260 can include, but are not limited to, an ammeter, a volt meter, a VAR meter, a gas chromatograph, an ohmmeter, a Hall Effect current sensor, a thermistor, a vibration sensor, an accelerometer, a passive infrared sensor, a photocell, a pressure sensor, an ultrasonic sensor, a gamma densitometer, a thermometer, a thermocouple, and a resistance temperature detector. A parameter that can be measured by a sensor device 260 can include, but is not limited to, current, voltage, gas composition, power, resistance, vibration, position, pressure, flow, acceleration, and temperature.

In some cases, the parameter or parameters measured by a sensor device 260 can be communicated by the sensor device 260 to a controller 204. Further, a sensor device 260 can receive instructions (e.g., when to take measurements, how long to take measurements, the types of measurements to be taken) from a controller 204. For this to occur, each sensor 260 can use one or more of a number of communication protocols. A sensor device 260 can be located within its own housing as its own device. Alternatively, a sensor device 260 can be incorporated with another component (e.g., temperature regulating device 267, pressure regulating device 268) of the system 201. In certain example embodiments, a sensor device 260 can include one or more components (e.g., hardware processor, memory, energy storage device, power module) found in a controller 204, as described below.

In this example, there are five sensor devices 260 in the system 201. Sensor device 260-1 measures a pressure within the cavity 249 of the pressure vessel 240. Sensor device 260-2 measures a flow rate within a pipe 285. Sensor device 260-3 measures a temperature of the wall 241 of the body 244 of the pressure vessel 240. Sensor device 260-4 measures the power delivered to the motor 257 of the mixing device 250. The system 201 can have multiple sensor devices 260 that measure the same parameter but that have different locations throughout the system 201. For example, there can be multiple sensor devices 260-2 that measure flow in different pipes 285 in the system 201.

In certain example embodiments, the system 201 can include one or more PV content sources 270, where each PV content source 270 holds a different gas and/or liquid. In this case, there are three PV content sources 270 (PV content source 270-1, PV content source 270-2, and PV content source 270-3). When there are multiple PV content sources 270, one PV content source 270 can have the same content or a different content relative to the content contained in the other PV content sources 270 in the system 201 and/or the gas 295 and liquid 291 in the cavity 249 of the vessel 140. Each PV content source 270 can be connected to the pressure vessel 240 by piping 285.

The piping 285 can include tubular segments that are coupled end-to-end to transport liquid and/or gas from one location (e.g., PV content source 270-1) to another location (e.g., the pressure vessel 240). The piping 285 can be of any size, made of any suitable material, and can be bent or otherwise shaped for efficient routing. The piping 285 can also include fittings, glands, sleeves, and/or any other suitable components used to create and maintain a piping system. As discussed above, one or more control devices 275 (e.g., valves, regulators) can be used to regulate the medium (e.g., liquid, gas) that flows through the piping 285. These control devices 275 can be adjusted manually by a user. In addition, or in the alternative, a control device 275 can be controlled by a controller 204 using signal transfer links 205. In such a case, the controller 204 can control the control device 275 automatically (e.g., according to a procedure or algorithm) or by user instruction.

One or more pumps 280 can be included in the system 201 to facilitate the transfer of a liquid and/or gas from one location in the system 201 to another. For example, in this case, a pump 280 is used, through piping 285, to create an amount of flow rate of the liquid and/or gas through the piping 285. The pump 280 can use any of a number of technologies. For example, the pump 280 can be a continuous flow syringe pump. As another example, the pump 280 can be a piston cylinder pump. The operation of the pump 280 can be controlled manually by a user. In addition, or in the alternative, a pump 280 can be controlled by a controller 204 (in this case, controller 204-1) using signal transfer links 205. In such a case, the controller 204 can control the pump 280 automatically (e.g., according to a procedure or algorithm) or by user instruction. In some alternative embodiments, a pre-pressurized sample of gas and/or liquid can be delivered to the pressure vessel 240, with or without the use of a pump 280.

Also as discussed above, the system 201 can be used in a laboratory-type setting or in a field application (e.g., at a plant, in a processing facility, at a production facility). In any case, measures can be taken to ensure that the system 201 is safe during operation. For example, the pressure vessel 240 can be an explosion-proof enclosure. According to applicable industry standards, an explosion-proof enclosure is an enclosure that is configured to contain an explosion that originates inside, or can propagate through, the enclosure.

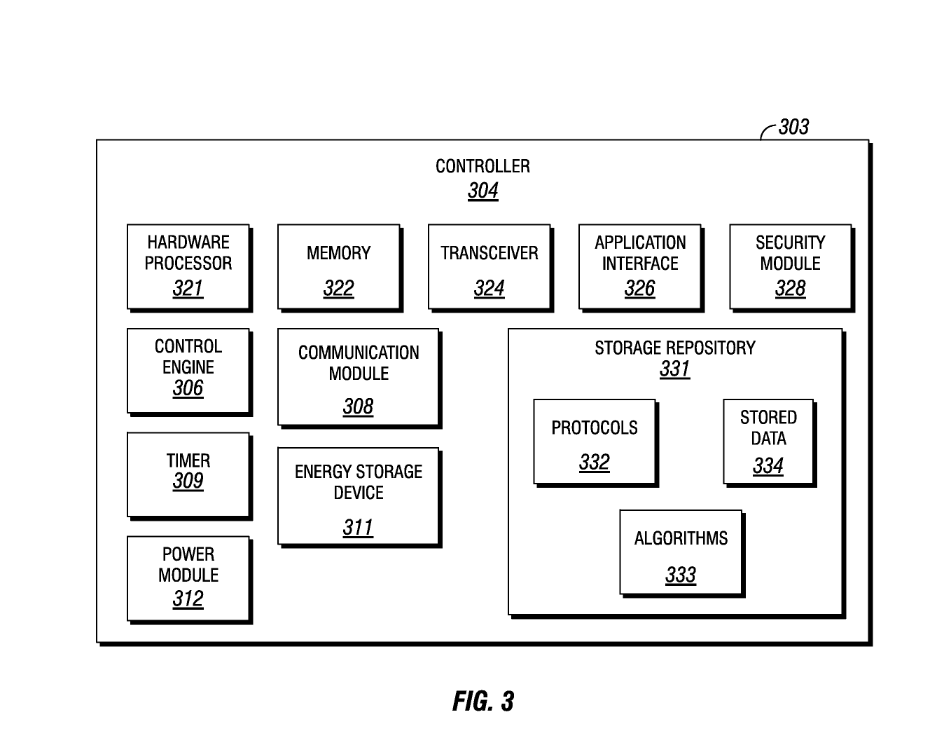

Also as discussed above, the system 201 can include one or more controllers 204. In this example, there are four controllers 204. Controller 204-1 controls the operation of the pump 280. Controller 204-2 controls the operation of the temperature control device 267. Controller 204-3 controls the operation of the pressure control device 268. Controller 204-4 acts as a master controller or network manager by controlling controller 204-1, controller 204-2, and controller 204-3. The four controllers 204 of FIG. 2 can be individual controllers that communicate with each other. Alternatively, the four controllers 204 of FIG. 2 can be compartmentalized functions within a single controller 204. More details about a controller are provided below with respect to FIG. 3. As stated above, the system 201 (or components thereof) can be placed in any of a number of environments. In such a case, any of a number of components of the system 201 can be configured to comply with applicable standards for any of a number of environments. For example, the pressure vessel 240 can be rated under applicable standards for subterranean and/or subsea environments.

FIG. 3 shows a system diagram of a controller 304, such as the controller 204 of FIG. 2 above. Referring to FIGS. 1-3, the controller 304 of FIG. 3 can include one or more of a number of components. Such components, can include, but are not limited to, a control engine 306, a communication module 308, a timer 309, an energy storage device 311, a power module 312, a storage repository 331, a hardware processor 321, a memory 322, a transceiver 324, an application interface 326, and, optionally, a security module 328. The components shown in FIG. 3 are not exhaustive, and in some embodiments, one or more of the components shown in FIG. 3 may not be included in an example controller. Any component of the controller 304 can be discrete or combined with one or more other components of the controller 304.

A user can use a user system (not shown), which may include a display (e.g., a GUI), to interact with the controller 304. The user can interact with (e.g., send data to, receive data from) the controller 304 (including portions thereof) via the application interface 326 (described below). The user can also interact with one or more other components (e.g., the pump 280, the temperature control device 267) of the system 201 using the controller 304. Interaction between the user and the controller 304 can be conducted using signal transfer links 205.

Each signal transfer link 205 can include wired (e.g., Class 1 electrical cables, Class 2 electrical cables, electrical connectors, electrical conductors, electrical traces on a circuit board, power line carrier, RS485) and/or wireless (e.g., Wi-Fi, visible light communication, cellular networking, Bluetooth, WirelessHART, ISA100) technology. For example, a signal transfer link 205 can be (or include) one or more electrical conductors that are coupled to the controller 304 and to a sensor 260. A signal transfer link 205 can transmit signals (e.g., power, communication signals, control signals, data) between the controller 304 and another component (e.g., pump 280, control device 275, sensor 260, temperature control device 267, pressure control device 268, mixing device 250) of the system 201. In some cases, one or more signal transfer links 205 can also transmit signals between components (e.g., between a sensor 260 and the temperature control device 267) of the system 201.

The controller 304 can interact with a user and/or any component of the system 201 using the application interface 326 in accordance with one or more example embodiments. Specifically, the application interface 326 of the controller 304 receives data (e.g., information, communications, instructions, updates to firmware) from and sends data (e.g., information, communications, instructions) to the user and/or any other component of the system 201. The user and/or one or more of the other components of the system 201 can include an interface to receive data from and send data to the controller 304 in certain example embodiments. Examples of such an interface can include, but are not limited to, a graphical user interface, a touchscreen, an application programming interface, a keyboard, a monitor, a mouse, a web service, a data protocol adapter, some other hardware and/or software, or any suitable combination thereof

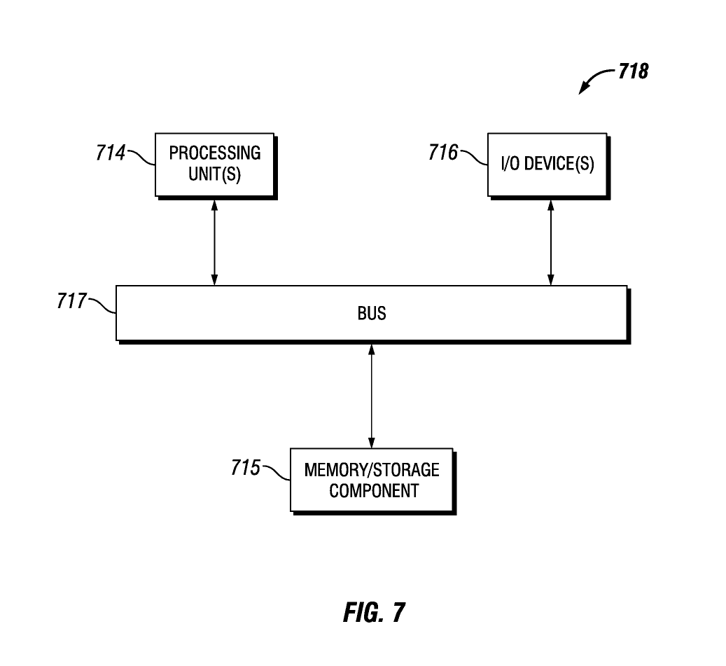

The controller 304, the user, and/or one or more of the other components of the system 201 can use their own system or share a system in certain example embodiments. Such a system can be, or contain a form of, an Internet-based or an intranet-based computer system that is capable of communicating with various software. A computer system includes any type of computing device and/or communication device, including but not limited to the controller 304. Examples of such a system can include, but are not limited to, a desktop computer with LAN, WAN, Internet or intranet access, a laptop computer with LAN, WAN, Internet or intranet access, a smart phone, a server, a server farm, an android device (or equivalent), a tablet, smartphones, and a personal digital assistant (PDA). Such a system can correspond to a computer system as described below with regard to FIG. 7.

Further, as discussed above, such a system can have corresponding software (e.g., user software, controller software, network manager software). The software can execute on the same or a separate device (e.g., a server, mainframe, desktop personal computer (PC), laptop, PDA, television, cable box, satellite box, kiosk, telephone, mobile phone, or other computing devices) and can be coupled by the communication network (e.g., Internet, Intranet, Extranet, Local Area Network (LAN), Wide Area Network (WAN), or other network communication methods) and/or communication channels, with wire and/or wireless segments according to some example embodiments. The software of one system can be a part of, or operate separately but in conjunction with, the software of another system within the system 201.

The controller 304 can include a housing 303. The housing 303 can include at least one wall that forms a cavity. Any one or more other components (e.g., the timer 309, the power module 312) of the controller 304 can be disposed within or on the housing 303. In some cases, the housing 303 of the controller 304 can be designed to comply with any applicable standards so that the controller 304 (or portions thereof) can be located in a particular environment (e.g., subsea, marine, subterranean, hazardous).

The housing 103 of the controller 304 can be used to house one or more components of the controller 304. As discussed above, the controller 304 in this example includes the control engine 306, the communication module 308, the timer 309, the energy storage device 311, the power module 312, the storage repository 331, the hardware processor 321, the memory 322, the transceiver 324, the application interface 326, and the optional security module 328. In alternative embodiments, any one or more of these or other components of the controller 304 can be disposed on the housing 303 and/or remotely from the housing 303.

The storage repository 331 can be a persistent storage device (or set of devices) that stores software and data used to assist the controller 304 in making determinations and communicating with the user and/or one or more of the other components of the system 201. In one or more example embodiments, the storage repository 331 stores one or more protocols 332, algorithms 333, and stored data 334. The protocols 332 can be any of a number of protocols (e.g., procedures, methods, method steps) that the control engine 306 of the controller 304 follows based on certain conditions at a point in time. One or more of the protocols 332 can be used to send and/or receive data between the controller 304 and the user 150 and/or one or more of the other components of the system 201. The protocols 332 can also include processes and procedures that are related to communications.

When a protocol 332 is used for communications, the protocol 332 can be used for wired and/or wireless communication. Examples of a protocol 332 can include, but are not limited to, Modbus, PROFIBUS, PROFINET, and Ethernet (for example, when data packets are transmitted over copper or fiber optic physical media). One or more of the protocols 332 can be a time-synchronized protocol. Examples of such time-synchronized protocols can include, but are not limited to, a highway addressable remote transducer (HART) protocol, a wireless HART protocol, and an International Society of Automation (ISA) 100 protocol. In this way, one or more of the protocols 332 can provide a layer of security to the data transferred within the system 100.

The algorithms 333 can be any formulas, logic steps, mathematical models, and/or other similar tools that the control engine 306 of the controller 304 uses to process data at a point in time based on certain conditions. An example of an algorithm 333 is measuring (using the sensor 260-4), storing (using the stored data 334 in the storage repository 331), and evaluating over time the current and voltage that the controller 304 delivers to the motor 257 of the mixing device 250. As another example, an algorithm 333 can be directed to continuously monitor the state of the gas 295 in the cavity 249 of the pressure vessel 240. As another example, an algorithm 333 can be directed to analyzing the stored power output by the energy storage devices 311 over time. As yet another example, an algorithm 333 can be used to processing data measured by one or more of the sensor devices 260.

Stored data 334 can be any data associated with the system 201 (including any components thereof), including but not limited to any measurements taken by the sensors 260, time measured by the timer 309, threshold values, current ratings for the motor 257, results of previously run or calculated algorithms 333, and nameplate data of each pump 280. Such data can be any type of data, including but not limited to historical data for the system 201 (including any components thereof), performance of the temperature regulating device 267, performance of the pressure regulating device 268, calculations, and measurements taken by one or more of the sensor modules 260. The stored data 334 can be associated with some measurement of time derived, for example, from the timer 309.

Examples of a storage repository 331 can include, but are not limited to, a database (or a number of databases), a file system, a hard drive, flash memory, some other form of solid state data storage, or any suitable combination thereof. The storage repository 331 can be located on multiple physical machines, each storing all or a portion of the protocols 332, the algorithms 333, and/or the stored data 334 according to some example embodiments. Each storage unit or device can be physically located in the same or in a different geographic location.

The storage repository 331 can be operatively connected to the control engine 306. In one or more example embodiments, the control engine 306 includes functionality to communicate with the user and/or one or more of the other components of the system 201. More specifically, the control engine 306 sends information to and/or receives information from the storage repository 331 in order to communicate with the user 150 and/or one or more of the other components of the system 201. As discussed below, the storage repository 331 can also be operatively connected to the communication module 308 in certain example embodiments.

In certain example embodiments, the control engine 306 of the controller 304 controls the operation of one or more components (e.g., the communication module 308, the timer 309, the transceiver 324) of the controller 304 and/or one or more components (e.g., temperature regulating device 267, pressure regulating device 268) of the system 201. For example, the control engine 306 can activate the communication module 308 when the communication module 308 is in “sleep” mode and when the communication module 308 is needed to send data received from another component (e.g., a sensor 260, the user) in the system 201.

As another example, the control engine 306 can acquire the current time using the timer 309. The timer 309 can enable the controller 304 to control the system 201 (including any components thereof). As yet another example, the control engine 306 can direct sensor 260-4 to measure and send power consumption information of the motor 257 of the mixing device 250 to the control engine 306. Further, the control engine 306 of the controller 304 can control the position of each control device 275 within the system 201.

The control engine 306 can use one or more protocols 332 and/or one or more algorithms 333 to evolve and/or dissolve gas within the pressure vessel 240 in a controlled manner. In other words, one or more protocols 332 and/or one or more algorithms 333 can be designed to draw out the time-dependent kinetics of the gas within the pressure vessel 240. The control engine 306 can accomplish this by controlling the pump 280, the mixing device 250, the control devices 275, the temperature regulating device 267, and the pressure regulating device 268 on a real-time basis, using data provided by the various sensors 260 in the system 201. The control engine 306 can control the operation of one or more sensors 260 in the system 201. The control engine 306 can also use the measurements taken by the sensors 260 to control the operation of one or more components (e.g., temperature regulating device 267, pressure regulating device 268) of the system 201 at a particular point in time.

The control engine 306 can generate an alarm when an operating parameter (e.g., total number of operating hours, number of consecutive operating hours, number of operating hours delivering power above a current level, input power quality, vibration, operating ambient temperature, operating temperature) of a component of the system 201 exceeds a threshold value, indicating possible present or future failure of the system 201 (or component thereof). The control engine 306 can further measure (using one or more sensors 260) and analyze any of a number of power (e.g., current, voltage, surges, faults) associated with a component (e.g., the mixing device 250) of the system 201 over time. Using one or more algorithms 333, the control engine 306 can predict the expected useful life of the component of the system 201 based on stored data 334, a protocol 332, one or more threshold values, and/or some other factor. The control engine 306 can also measure (using one or more sensors 260) and analyze the efficiency of the system 201 (or component thereof) over time. An alarm can be generated by the control engine 306 when the efficiency of the system 201 (or component thereof) falls below a threshold value, indicating failure of the system 201 (or component thereof).

In certain example embodiments, the control engine 306 can regulate the temperature and/or pressure within the pressure vessel 240. For example, the control engine 306 can determine (based on a measurement made by sensor 260-3) whether to raise the temperature within the pressure vessel 240 using the temperature regulating device 267. As another example, the control engine 306 can determine (based on a measurement made by sensor 260-1) whether to decrease the pressure within the pressure vessel 240 when the pressure exceeds a high pressure threshold value. As yet another example, the control engine 306 can determine (based on a measurement made by a sensor 260) whether to activate the mixing device 250 and at what speed.

The control engine 306 can provide, using the signal transfer links 205, power, control, communication, and/or other similar signals to the user and one or more of the other components of the system 201. Similarly, the control engine 306 can receive power, control, communication, and/or other similar signals from the user and one or more of the other components of the system 201. The control engine 306 can control each sensor 260 automatically (for example, based on one or more algorithms 333 stored in the storage repository 331) and/or based on power, control, communication, and/or other similar signals received from another device through a signal transfer link 205. The control engine 306 may include a printed circuit board, upon which the hardware processor 321 and/or one or more discrete components of the controller 304 are positioned.

In certain embodiments, the control engine 306 of the controller 304 can communicate with one or more components of a system external to the system 201 in furtherance of optimizing the evolution and/or dissolution of a gas 295. For example, the control engine 306 can interact with an inventory management system by ordering a component (e.g., a control device 275) to replace a component of the system 201 that the control engine 306 has determined to fail or be failing. As another example, the control engine 306 can interact with a workforce scheduling system by scheduling a maintenance crew to repair or replace a component of the system 201 when the control engine 306 determines that the component requires maintenance or replacement. In this way, the controller 304 is capable of performing a number of functions beyond what could reasonably be considered a routine task.

In certain example embodiments, the control engine 306 can include an interface that enables the control engine 306 to communicate with one or more components (e.g., a pressure regulating device 268) of the system 201. For example, if the system 201 (or portion thereof) operates under IEC Standard 62386, then the system 201 can have a serial communication interface that will transfer data (e.g., stored data 334) measured by the sensors 260. In such a case, the control engine 306 can also include a serial interface to enable communication with one or more components within the system 201. Such an interface can operate in conjunction with, or independently of, the protocols 332 used to communicate between the controller 304 and the user and one or more of the other components of the system 201.

The control engine 306 (or other components of the controller 304) can also include one or more hardware components and/or software elements to perform its functions. Such components can include, but are not limited to, a universal asynchronous receiver/transmitter (UART), a serial peripheral interface (SPI), a direct-attached capacity (DAC) storage device, an analog-to-digital converter, an inter-integrated circuit (I²C), and a pulse width modulator (PWM).

The communication module 308 of the controller 304 determines and implements the communication protocol (e.g., from the protocols 332 of the storage repository 331) that is used when the control engine 306 communicates with (e.g., sends signals to, receives signals from) the user and/or one or more of the other components of the system 201. In some cases, the communication module 308 accesses the stored data 334 to determine which communication protocol 332 is used to communicate with the sensor 260 associated with the stored data 334. In addition, the communication module 308 can interpret the communication protocol 332 of a communication received by the controller 304 so that the control engine 306 can interpret the communication.

The communication module 308 can send and receive data between the user, one or more of the other components of the system 201, and the controller 304. The communication module 308 can send and/or receive data in a given format that follows a particular protocol 332. The control engine 306 can interpret the data packet received from the communication module 308 using the protocol information stored in the storage repository 331. The control engine 306 can also facilitate the data transfer between one or more sensors 260, one or more of the other components of the system 201, and the user by converting the data into a format understood by the communication module 308.

The communication module 308 can send data (e.g., protocols 332, algorithms 333, stored data 334, operational information, alarms) directly to and/or retrieve data directly from the storage repository 331. Alternatively, the control engine 306 can facilitate the transfer of data between the communication module 308 and the storage repository 331. The communication module 308 can also provide encryption to data that is sent by the controller 304 and decryption to data that is received by the controller 304. The communication module 308 can also provide one or more of a number of other services with respect to data sent from and received by the controller 304. Such services can include, but are not limited to, data packet routing information and procedures to follow in the event of data interruption.

The timer 309 of the controller 304 can track clock time, intervals of time, an amount of time, and/or any other measure of time. The timer 309 can also count the number of occurrences of an event, whether with or without respect to time. Alternatively, the control engine 306 can perform the counting function. The timer 309 is able to track multiple time measurements concurrently. The timer 309 can track time periods based on an instruction received from the control engine 306, based on an instruction received from the user, based on an instruction programmed in the software for the controller 304, based on some other condition or from some other component, or from any combination thereof.

The timer 309 can be configured to track time when there is no power delivered to the controller 304 (e.g., the power module 312 malfunctions) using, for example, a super capacitor or a battery backup. In such a case, when there is a resumption of power delivery to the controller 304, the timer 309 can communicate any aspect of time to the controller 304. In such a case, the timer 309 can include one or more of a number of components (e.g., a super capacitor, an integrated circuit) to perform these functions.

An optional energy storage device 311 can be any of a number of rechargeable batteries or similar storage devices that are configured to charge using some source of power (e.g., the primary power provided to the controller 304). The energy storage device 311 can use one or more of any type of storage technology, including but not limited to a battery, a flywheel, an ultracapacitor, and a supercapacitor. If the energy storage device 311 includes a battery, the battery technology can vary, including but not limited to lithium ion, nickel-cadmium, lead/acid, solid state, graphite anode, titanium dioxide, nickel cadmium, nickel metal hydride, nickel iron, alkaline, and lithium polymer. In some cases, one or more of the energy storage devices 311 charge using a different level and/or type of power relative to the level and type of power received by the controller 304. In such a case, the power module 312 can convert, invert, transform, and/or otherwise manipulate the primary power to the level and type of power used to charge the energy storage devices 311. There can be any number of energy storage devices 311.

The power module 312 of the controller 304 provides power to one or more other components (e.g., timer 309, control engine 306) of the controller 304. In addition, in certain example embodiments, the power module 312 can provide power to one or more other components (e.g. a sensor 260) of the system 201. The power module 312 can include one or more of a number of single or multiple discrete components (e.g., transistor, diode, resistor), and/or a microprocessor. The power module 312 may include a printed circuit board, upon which the microprocessor and/or one or more discrete components are positioned. In some cases, the power module 312 can include one or more components that allow the power module 312 to measure one or more elements of power (e.g., voltage, current) that is delivered to and/or sent from the power module 312. Alternatively, the controller 304 can include a power storage device (not shown) to measure one or more elements of power that flows into, out of, and/or within the controller 304.

The power module 312 can include one or more components (e.g., a transformer, a diode bridge, an inverter, a converter) that receives power (for example, through an electrical cable) from a source external to the system 201 and generates power of a type (e.g., AC, DC) and level (e.g., 12V, 24V, 321V) that can be used by the other components of the controller 304 and/or the system 201. The power module 312 can use a closed control loop to maintain a preconfigured voltage or current with a tight tolerance at the output. The power module 312 can also protect the rest of the electronics (e.g., hardware processor 321, transceiver 324) in the controller 304 from surges generated in the line.

In addition, or in the alternative, the power module 312 can be a source of power in itself to provide signals to the other components of the controller 304 and/or the system 201. For example, the power module 312 can be a battery. As another example, the power module 312 can be a localized photovoltaic power system. The power module 312 can also have sufficient isolation in the associated components of the power module 312 (e.g., transformers, opto-couplers, current and voltage limiting devices) so that the power module 312 is certified to provide power to an intrinsically safe circuit.

In certain example embodiments, the power module 312 of the controller 304 can also provide power and/or control signals, directly or indirectly, to one or more of the sensors 260. In such a case, the control engine 306 can direct the power generated by the power module 312 to the sensors 260 of the system 201. In this way, power can be conserved by sending power to the sensors 260 of the system 201 when those devices need power, as determined by the control engine 306.

The hardware processor 321 of the controller 304 executes software, algorithms, and firmware in accordance with one or more example embodiments. Specifically, the hardware processor 321 can execute software on the control engine 306 or any other portion of the controller 304, as well as software used by the user and/or one or more of the other components of the system 201. The hardware processor 321 can be an integrated circuit, a central processing unit, a multi-core processing chip, SoC, a multi-chip module including multiple multi-core processing chips, or other hardware processor in one or more example embodiments. The hardware processor 321 is known by other names, including but not limited to a computer processor, a microprocessor, and a multi-core processor.

In one or more example embodiments, the hardware processor 321 executes software instructions stored in memory 322. The memory 322 includes one or more cache memories, main memory, and/or any other suitable type of memory. The memory 322 can include volatile and/or non-volatile memory. The memory 322 is discretely located within the controller 304 relative to the hardware processor 321 according to some example embodiments. In certain configurations, the memory 322 can be integrated with the hardware processor 321.

In certain example embodiments, the controller 304 does not include a hardware processor 321. In such a case, the controller 304 can include, as an example, one or more field programmable gate arrays (FPGA) insulated-gate bipolar transistors (IGBTs), and/or one or more integrated circuits (ICs). Using FPGAs, IGBTs, ICs, and/or other similar devices known in the art allows the controller 304 (or portions thereof) to be programmable and function according to certain logic rules and thresholds without the use of a hardware processor. Alternatively, FPGAs, IGBTs, ICs, and/or similar devices can be used in conjunction with one or more hardware processors 321.

The transceiver 324 of the controller 304 can send and/or receive control and/or communication signals. Specifically, the transceiver 324 can be used to transfer data between the controller 304 and the user and/or one or more of the other components of the system 201. The transceiver 324 can use wired and/or wireless technology. The transceiver 324 can be configured in such a way that the control and/or communication signals sent and/or received by the transceiver 324 can be received and/or sent by another transceiver that is part of the user and/or one or more of the other components of the system 201. The transceiver 324 can use any of a number of signal types, including but not limited to radio signals.

When the transceiver 324 uses wireless technology, any type of wireless technology can be used by the transceiver 324 in sending and receiving signals. Such wireless technology can include, but is not limited to, Wi-Fi, visible light communication, cellular networking, and Bluetooth. The transceiver 324 can use one or more of any number of suitable communication protocols (e.g., ISA100, HART) when sending and/or receiving signals. Such communication protocols can be stored in the communication protocols 332 of the storage repository 331. Further, any transceiver information for the user and/or one or more of the other components of the system 201 can be part of the stored data 334 (or similar areas) of the storage repository 331.

Optionally, in one or more example embodiments, the security module 328 secures interactions between the controller 304, the user and/or one or more of the other components of the system 201. More specifically, the security module 328 authenticates communication from software based on security keys verifying the identity of the source of the communication. For example, user software may be associated with a security key enabling the software of the user to interact with the controller 304 and/or the sensors 260. Further, the security module 328 can restrict receipt of information, requests for information, and/or access to information in some example embodiments.

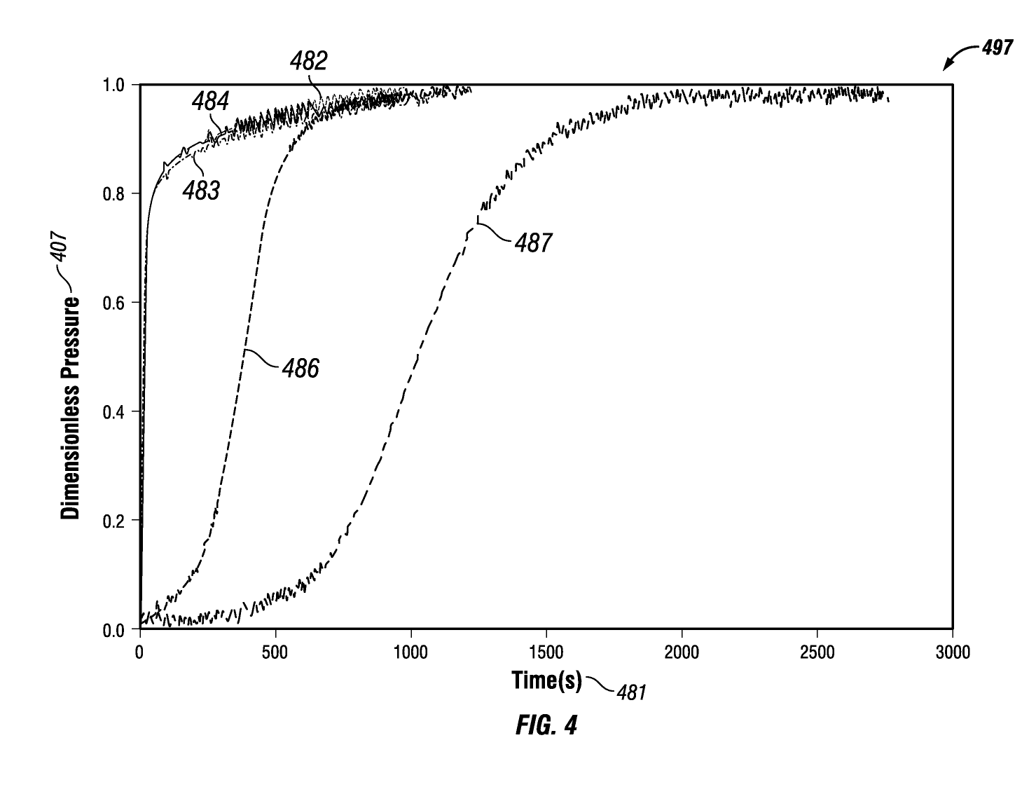

FIG. 4 shows a graph 497 depicting the effect of shear on gas evolution in accordance with certain example embodiments. Referring to FIGS. 1-4, the graph 497 of FIG. 4 shows the result of mixing continuously throughout the gas evolution experiment. As explained above, the mixing device (e.g., mixing device 250) can be used to control the agitation level within the pressure vessel 240, as well as the duration of agitation. The graph 497 of FIG. 4 has time 481 (in seconds) along the horizontal axis, and dimensionless pressure 407 along the vertical axis. Five different plots are shown on the graph 497, where all of the plots represent different mixing speeds (agitation caused by the mixing device 250 within the pressure vessel 240) for the same liquid 291.

Plot 482 represents a mixing speed of 85%. Plot 483 represents a mixing speed of 75%. (In some cases, rather than a mixing speed, plot 482 (or any other plots representing mixing speeds herein) can be represented in terms of some other unit of measurement, including but not limited to rpm. Plot 484 represents a mixing speed of 70%. Plot 486 represents a mixing speed of 50%. Mixing speed can also be expressed in terms of rotations per minute (rpm). Plot 487 represents a mixing speed of 35%. These graphs show that, by reducing the mixing speed in a controlled manner, as used in example embodiments, the pressure takes considerably longer to rise, which correlates directly with a longer gas evolution time.

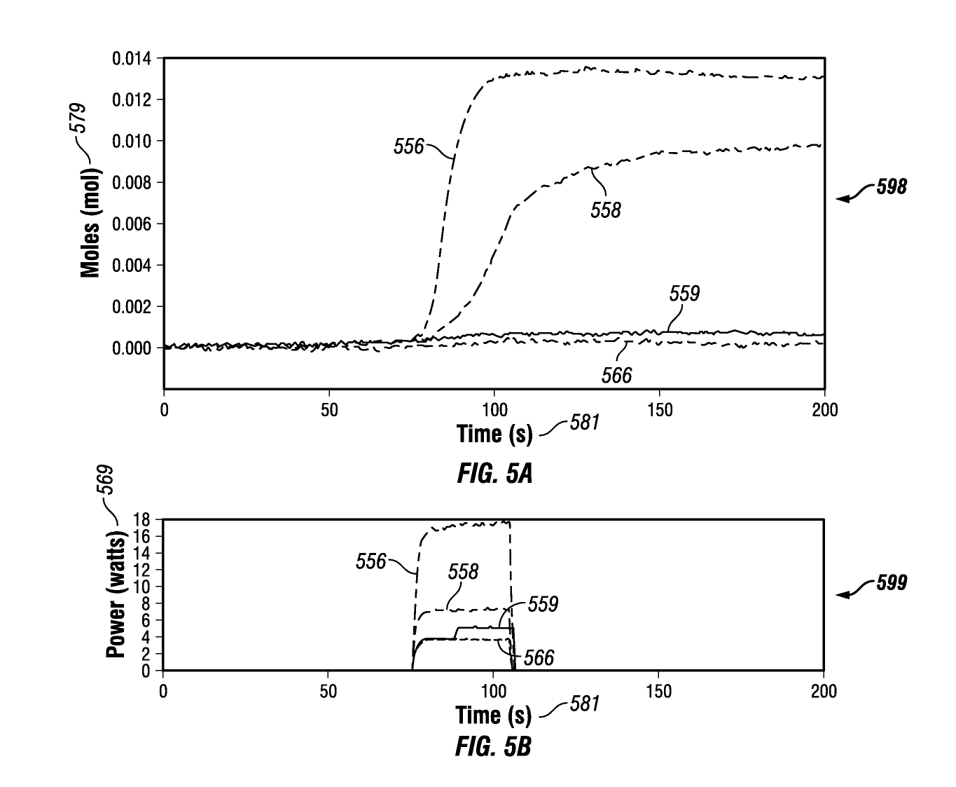

FIGS. 5A and 5B show graphs related to gas evolution in accordance with one or more example embodiments. Referring to FIGS. 1-5B, the graph 598 of FIG. 5A has time 581 (in seconds) along the horizontal axis, and moles 579 along the vertical axis. The graph 599 of FIG. 5B also has time 581 (in seconds) along the horizontal axis, but power 569 (in watts, delivered to the motor 257 of the mixing device 250) along the vertical axis. In this case, the graph 598 and graph 599 show mixing that occurs for a finite period of time (sometimes called “burst mixing”).

Graph 598 and graph 599 each have four plots, all tested at the same temperature (around 25° C.). For both graphs of FIGS. 5A and 5B, plot 566 is for a viscous oil (room temperature viscosity of about 200 cP) with a mixing speed of 35%. Plot 559 is for a less viscous oil (room temperature viscosity of about 20 cP) with a mixing speed of 35%. Plot 558 is for the same oil as for plot 559, with a mixing speed of 50%. Plot 557 is for the same oil as for plot 559, with a mixing speed of 70%.

The times 581 of graph 598 and graph 599 are aligned. As the amount of power delivered by the controller 304 to the motor 257 of the mixing device 250 increases, the shear of the liquid 291 within the cavity 249 of the pressure vessel 240 increases. In addition, the elevated mixing rate tends to release more moles of the gas 295 in a shorter period of time, where the slower mixing rate releases the moles of the gas 295 at a much slower rate.

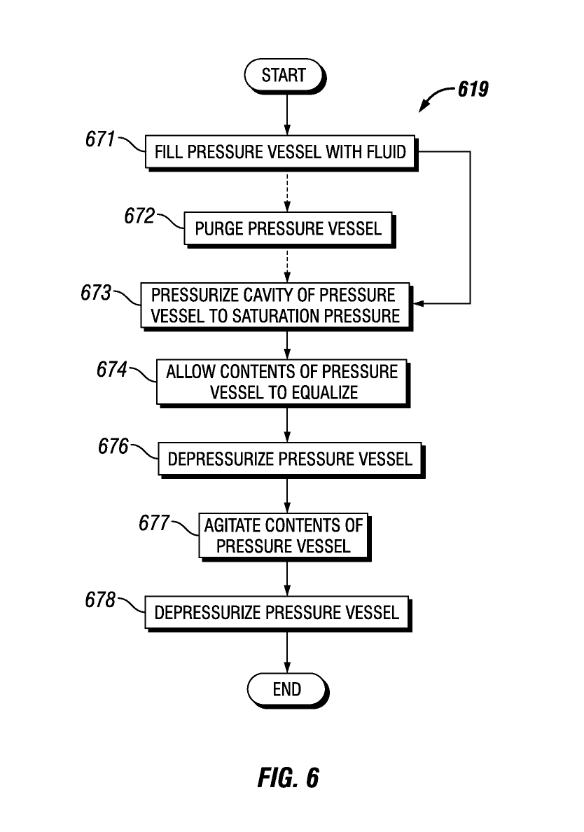

FIG. 6 is a flowchart of a method 619 for evolving and dissolving gas in accordance with one or more example embodiments. While the various steps in this flowchart are presented and described sequentially, one of ordinary skill in the art will appreciate that some or all of the steps are executed in different orders, combined or omitted, and some or all of the steps are executed in parallel depending upon the example embodiment. Further, in one or more of the example embodiments, one or more of the steps described below are omitted, repeated, and/or performed in a different order.

In addition, a person of ordinary skill in the art will appreciate that additional steps not shown in FIG. 6, is included in performing this method in certain example embodiments. Accordingly, the specific arrangement of steps should not be construed as limiting the scope. In addition, a particular computing device, as described, for example, in FIG. 7 below, is used to perform one or more of the steps for the method 619 described below in certain example embodiments.

Referring to FIGS. 1-6, the example method 619 begins at the START step and proceeds to step 671, where filling the pressure vessel 240 with liquid 291. The liquid 291 can originate from a PV content source 270 and flow through piping 285 to the pressure vessel 240. The controller 304 can control the pump 280 and/or a control device 275 to draw the liquid 291 out of the PV content source 270. The liquid 291 can have known properties and content. Examples of a liquid 291 can include, but are not limited to, water, mineral oil, model oils, hydrocarbons, and crude oil.

In optional step 672, once the liquid 291 is in the cavity 249 of the pressure vessel 240, the pressure vessel 240 is purged with an inert gas (e.g., nitrogen) to remove any oxygen from the cavity 249 of the pressure vessel 240. By doing so, if the liquid 291 and/or the gas 295 include carbon, the risk of an explosion can be reduced. Once the oxygen has been removed, then the cavity 249 of the pressure vessel 240 is subsequently purged to remove the nitrogen or other gas used in the initial purge. The purging gases can originate from one or more PV content sources 270, facilitated through the piping 285 and indirectly controlled by the controller 304.

In step 673, the cavity 249 of the pressure vessel 240 is closed to the atmosphere and pressurized to a saturation pressure. The cavity 249 is pressurized using the pressure regulating device 268, which is controlled by the controller 304. The pressure within the cavity 249 of the pressure vessel 240 is measured by sensor 260-1, and those readings are provided to the controller 304. As the cavity 249 of the pressure vessel 240 approaches the saturation pressure, data is collected by one or more sensors 260 and interpreted by the controller 304 for a solubility or dissolution test, at which time the temperature (measured by sensor 260-3) can be controlled, using the temperature regulating device 267 under control of the controller 304, for changing viscosity of the liquid 291.

The controller can control the motor 257 mixing device 250 to operate, which moves the paddle 255 within the cavity 249. Moving the paddle 255 in the liquid 291 adds energy/shear to the liquid 291. As this occurs, sensor 260-1 collects pressure data from within the cavity 249 of the pressure vessel 240, and the controller 304 stores and performs calculations using this data over time. Using the known volume of the gas 295 coupled with the temperature of the gas 295 in the gas phase, the pressure measured by the sensor 260-1 can be converted to a moles of gas 295, and therefore the amount of moles that go into the liquid 291 via the pressure can be monitored using, for example, a sensor device 260. The dissolution rate of the gas 295 is defined as the time-dependent behavior of moles added to the liquid 291 through monitoring the volume, temperature, and pressure of the gas 295 and converting using idea gas law or EOS relationships.

During this time, the controller 304, with the aid of measurements made by the sensors 260, can also measure the effect of additional parameters, including but not limited to shear, solids, rate of pressurization, gas-to-oil ration (GOR), liquid viscosity, and emulsions. The controller 304 can also use measurements made by additional sensors 260 to detect the behavior of the liquid 291. These additional sensors 260 can include and/or use ultrasonics or gamma densitometers to detect the formation of foam, and the controller 304 can use these measurements to differentiate between the gas 295, the liquid 291, and foam.

Once the desired saturation pressure is reached, in step 674, the contents of the pressure vessel 240 are left alone for a time. During the time, the contents of the pressure vessel 240 come to equilibrium as the gas 295 dissolves into the liquid 291. One or more sensors 260 are used to measured various parameters during this step, and the controller 304 collects and analyzes these measurements. Eventually, the pressure within the cavity 249 reaches a defined saturation pressure/level.

Once saturation at the desired pressure has been achieved, then depressurization can begin. In step 676, the cavity 249 of the pressure vessel 240 is depressurized. The controller 304 controls how and the rate at which the cavity 249 of the pressure vessel 240 is depressurized. For example, the controller 304 can control the pump 280 to slowly depressurize the cavity 249 of the pressure vessel 240. This depressurization can be done in a very controlled manner. As an example, the cavity 249 of the pressure vessel 240 can be depressurized at a rate as low as 0.5 psi/min. This low rate of depressurization ensures that the gas 295 does not begin to evolve as the thermodynamic conditions change with the decrease in pressure.

The pressure vessel 240 is depressurized to a certain pressure, which will vary depending on the desired level of supersaturation. As the pressure vessel 240 is depressurized, the contents of the cavity 249 become supersaturated. During this step, the mixing device 250 may not be used in certain example embodiments. In this way, there is little to no agitation to the contents within the cavity 249 during depressurization, which helps ensure that a negligible amount of the gas 295 is evolved. Alternatively, the mixing device 250 can operate (e.g., continuously, intermittently, randomly, at a constant level, at a variable level) during some or all of the evolution and/or dissolution process, including as the pressure vessel 240 is being depressurized.

From here, evolution of the gas 295 begins. In step 677, the contents within the cavity 249 of the pressure vessel 240 are agitated. For example, the controller 304 sends power and control signals to the mixing device 250, causing the motor 257 to rotate the paddle 255 within the cavity 249 at a controlled rate. Readings from one or more sensors 260 (e.g., sensor 260-4 for power delivered to the motor 257, sensor 260-3 for temperature within the cavity 249, sensor 260-1 to measure pressure within the cavity 249) are used by the controller 304 to make adjustments to the speed of the paddle 255. During this process, sensor 260-1 can measure (e.g., continually, periodically) the pressure within the cavity 249 and provide these measurements to the controller 304. The controller 304 tracks the pressure measured by the sensor 260-1 as the gas 295 evolves, similar to how the pressures measured by the controller 304 were tracked during step 673 as the gas 295 was being dissolved. The pressure response of the gas 295 during evolution can be converted to moles (by the same methods mentioned above in step 673) to ensure the transient response (and therefore the rate of evolution of the gas 295) accounts for any slight temperature changes in the gas 295 in the head space 293 within the cavity 249.

Varying a number of factors/parameters (e.g., rate of agitation, method of agitation, addition of solids, using different coatings and/or textures on the inner surface 262 of the wall 241 of the body 244 of the pressure vessel 240, temperature changes) can have varying effects on evolution and/or dissolution of the gas 295. For example, varying one or more of these factors/parameters can cause the formation of foam within the cavity 249, as well as changes to the gas-liquid interface. Examples of parameters that can be controlled to effect the evolution rate of the gas 295 can include, but are not limited to, viscosity (through liquid temperature), agitation (through energy dissipation from the paddle 255), and supersaturation (through finitely controlling the pressure drop within the cavity 249). Example embodiments can be used to understand the effects of various parameters (e.g., emulsions, hydrates, waxes, asphaltenes, sand, and other solids) commonly found in a field operation, such as shown in FIG. 1, on the evolution and/or dissolution of the gas 295. Eventually, the contents of the pressure vessel 240 reach a new equilibrium, which represents completion of the gas evolution.

In step 678, the pressure vessel 240 is depressurized. Delivery of power and control from the controller 304 to the mixing device 250 is stopped before depressurization of the pressure vessel 240 begins. The pressure vessel 240 can be depressurized manually by a user or automatically by the controller 304. Upon completion of step 676, the END step ends the method 619.

As stated above, any of the steps of the method 619 of FIG. 6 can be repeated. For example, one or more steps of the method 619 can be repeated to control and/or measure the amount of gas 295 retrained in the liquid 291. In such a case, a tracer can be added to the gas 295 in the headspace 293. The tracer concentration in liquid 291 can be used to determine a difference in volume fractions between re-entrained gas and evolved gas.

FIG. 7 illustrates one embodiment of a computing device 718 that implements one or more of the various techniques described herein, and which is representative, in whole or in part, of the elements described herein pursuant to certain example embodiments. Computing device 718 is one example of a computing device and is not intended to suggest any limitation as to scope of use or functionality of the computing device and/or its possible architectures. Neither should computing device 718 be interpreted as having any dependency or requirement relating to any one or combination of components illustrated in the example computing device 718.

Computing device 718 includes one or more processors or processing units 714, one or more memory/storage components 715, one or more input/output (1/0) devices 716, and a bus 717 that allows the various components and devices to communicate with one another. Bus 717 represents one or more of any of several types of bus structures, including a memory bus or memory controller, a peripheral bus, an accelerated graphics port, and a processor or local bus using any of a variety of bus architectures. Bus 717 includes wired and/or wireless buses.

Memory/storage component 715 represents one or more computer storage media. Memory/storage component 715 includes volatile media (such as random access memory (RAM)) and/or nonvolatile media (such as read only memory (ROM), flash memory, optical disks, magnetic disks, and so forth). Memory/storage component 715 includes fixed media (e.g., RAM, ROM, a fixed hard drive, etc.) as well as removable media (e.g., a Flash memory drive, a removable hard drive, an optical disk, and so forth).

One or more I/O devices 716 allow a customer, utility, or other user to enter commands and information to computing device 718, and also allow information to be presented to the customer, utility, or other user and/or other components or devices. Examples of input devices include, but are not limited to, a keyboard, a cursor control device (e.g., a mouse), a microphone, a touchscreen, and a scanner. Examples of output devices include, but are not limited to, a display device (e.g., a monitor or projector), speakers, outputs to a lighting network (e.g., DMX card), a printer, and a network card.

Various techniques are described herein in the general context of software or program modules. Generally, software includes routines, programs, objects, components, data structures, and so forth that perform particular tasks or implement particular abstract data types. An implementation of these modules and techniques are stored on or transmitted across some form of computer readable media. Computer readable media is any available non-transitory medium or non-transitory media that is accessible by a computing device. By way of example, and not limitation, computer readable media includes “computer storage media”.

“Computer storage media” and “computer readable medium” include volatile and non-volatile, removable and non-removable media implemented in any method or technology for storage of information such as computer readable instructions, data structures, program modules, or other data. Computer storage media include, but are not limited to, computer recordable media such as RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which is used to store the desired information and which is accessible by a computer.

The computer device 718 is connected to a network (not shown) (e.g., a local area network (LAN), a wide area network (WAN) such as the Internet, cloud, or any other similar type of network) via a network interface connection (not shown) according to some example embodiments. Those skilled in the art will appreciate that many different types of computer systems exist (e.g., desktop computer, a laptop computer, a personal media device, a mobile device, such as a cell phone or personal digital assistant, or any other computing system capable of executing computer readable instructions), and the aforementioned input and output means take other forms, now known or later developed, in other example embodiments. Generally speaking, the computer system 718 includes at least the minimal processing, input, and/or output means necessary to practice one or more embodiments.

Further, those skilled in the art will appreciate that one or more elements of the aforementioned computer device 718 is located at a remote location and connected to the other elements over a network in certain example embodiments. Further, one or more embodiments is implemented on a distributed system having one or more nodes, where each portion of the implementation (e.g., control engine 306) is located on a different node within the distributed system. In one or more embodiments, the node corresponds to a computer system. Alternatively, the node corresponds to a processor with associated physical memory in some example embodiments. The node alternatively corresponds to a processor with shared memory and/or resources in some example embodiments.

Using example embodiments described herein, it is possible to better predict how a gas can evolve and/or dissolve when combined with a known liquid under a given set of conditions. With example embodiments, these conditions (e.g., pressure, temperature) are tightly controlled based on actual values measured by a number of sensing devices over a period of time. Results of trials using example embodiments can be applied to real-life applications, such as extractions of a subterranean resource from a wellbore drilled into a subterranean formation. As a result, in the application of field operations (or any of a number of other applications), example embodiments can provide significant cost and time savings, a higher level of reliability, greater ease of use, and significantly more effective extraction of subterranean resources.

Although embodiments described herein are made with reference to example embodiments, it should be appreciated by those skilled in the art that various modifications are well within the scope and spirit of this disclosure. Those skilled in the art will appreciate that the example embodiments described herein are not limited to any specifically discussed application and that the embodiments described herein are illustrative and not restrictive. From the description of the example embodiments, equivalents of the elements shown therein will suggest themselves to those skilled in the art, and ways of constructing other embodiments using the present disclosure will suggest themselves to practitioners of the art. Therefore, the scope of the example embodiments is not limited herein.

What is claimed is:

1. A system for evolving and dissolving a gas with a liquid, the system comprising:
a pressure vessel in which the liquid mixed with the gas is disposed;
at least one regulating device that regulates a parameter within the pressure vessel;
at least one sensor that measures the at least one parameter as a function of time, wherein the at least one parameter is associated with the gas within the pressure vessel; and
a controller coupled to the at least one sensor and the at least one regulating device, wherein the controller controls the at least one regulating device, based on measurements of the at least one parameter taken by the at least one sensor, to evolve and dissolve the gas within the pressure vessel.

2. The system of claim 1, further comprising:
a pump coupled to the controller, wherein the pump extracts the gas from the gas source and injects the gas into the pressure vessel.

3. The system of claim 1, further comprising:
an image capture device coupled to the controller, wherein the image capture device captures a plurality of images within the pressure vessel as the gas evolves and dissolves.

4. The system of claim 3, wherein the pressure vessel comprises at least one view port disposed in a wall of the pressure vessel, wherein the image capturing device captures the plurality of images through the view port.

5. The system of claim 1, further comprising:
a mixing device coupled to the controller, wherein the mixing device, based on instructions received from the controller, mixes the liquid and the gas suspended in the liquid within the pressure vessel.

6. The system of claim 5, wherein the mixing device comprise a motor and a paddle, wherein the paddle is disposed within the pressure vessel with the liquid.

7. The system of claim 6, wherein the motor is magnetically-coupled to the paddle.

8. The system of claim 7, wherein the amount of power delivered by the motor to the paddle is measured by the at least one sensor.

9. The system of claim 5, wherein the mixing device operates during evolution and dissolution of the gas.

10. The system of claim 5, wherein the pressure vessel comprises at least one baffle for controlling a flow of the liquid within the pressure vessel when the mixing device is operating.

11. The system of claim 1, wherein the at least one regulating device comprises at least one selected from a group consisting of a pressure regulating device and a temperature regulating device.

12. The system of claim 1, further comprising:
a gas source coupled to the pressure vessel, wherein the gas source supplies the gas into the pressure vessel with the liquid.

13. A method for studying characteristics of a gas in the presence of a liquid, the method comprising:
filling a pressure vessel with the liquid, wherein the liquid comprises the gas therein;
pressurizing, using a controller that controls a pressure regulating device based on a first plurality of measurements at a first time made by at least one sensor, the pressure vessel to a first pressure;
allowing the liquid and gas inside the pressure vessel to equilibrate;
measuring, using the at least one sensor, a second plurality of measurements at a second time; and
evaluating, using the controller, the first plurality of measurements, and the second plurality of measurements, the characteristics of the gas during dissolution.

14. The method of claim 13, further comprising:
agitating, using a mixing device controlled by the controller, the gas and the liquid within the pressure vessel after pressurizing the pressure vessel to the first pressure and before measuring the second plurality of measurements at the second time.

15. The method of claim 13, further comprising:
depressurizing, after evaluating the characteristics of the gas during dissolution, using the controller to control the pressure regulating device, the pressure vessel;
agitating, using a mixing device controlled by the controller, the gas and the liquid within the pressure vessel;
measuring, using the at least one sensor, a third plurality of measurements at a third time; and
evaluating, using the controller and the third plurality of measurements, the characteristics of the gas during evolution.

16. The method of claim 15, wherein the pressure vessel is depressurized until the gas is in a super-saturated state.

17. The method of claim 15, wherein a dissolution rate and an evolution rate of the gas is based, in part, on the number of moles of the gas in a head space within the pressure vessel.

18. The method of claim 13, wherein the pressure vessel is purged to remove oxygen prior to pressuring the pressure vessel to the first pressure.

19. The method of claim 13, wherein the gas is injected into the pressure vessel with the liquid before pressurizing the pressure vessel.

20. A method for studying characteristics of a gas in the presence of a liquid, the method comprising:
saturating a combination of the liquid and the gas within the pressure vessel;
agitating, using a mixing device controlled by a controller, the gas and the liquid within the pressure vessel;
measuring, using at least one sensor, a plurality of measurements at a first time; and
evaluating, using the controller and the plurality of measurements, the characteristics of the gas during evolution.
